(19) United States
(12) Patent Application Publication
(10) Pub. No.: US 2017/0125035 A1
(43) Pub. Date: May 4, 2017

(54) CONTROLLING SMART DEVICE BY VOICE

(71) Applicant: Xiaomi Inc., Beijing (CN)

(72) Inventors: Sitai GAO, Beijing (CN); Yi DING, Beijing (CN); Enxing HOU, Beijing (CN)

(21) Appl. No.: 15/232,812

(22) Filed: Aug. 10, 2016

(30) Foreign Application Priority Data
Oct. 28, 2015 (CN) 201510712870.6

(51) Int. Cl. G10L 25/72; H04W 4/02; H04M 1/725

(52) U.S. Cl. CPC G10L 25/72; H04M 1/72569; H04W 4/025; G10L 2021/02166

(57) ABSTRACT

A method and device for controlling a smart device are provided. The method includes: receiving voice data returned separately by multiple smart devices; processing the multiple voice data to obtain optimized voice data; and controlling the smart device corresponding to the voice data based on the optimized voice data. Accordingly, the control device may process voice data from different locations to obtain optimized voice data, and control, based on the optimized voice data, the smart device corresponding to the optimized voice data, thereby achieving a voice control on the smart device, providing convenience for a user to control the smart device, and optimizing user experience.

### CROSS-REFERENCE TO RELATED APPLICATIONS

This application is based on and claims priority to Chinese Patent Application No. 201510712870.6, filed on Oct. 28, 2015, the entire contents of which are incorporated herein by reference.

### TECHNICAL FIELD

The present disclosure relates to the field of smart home technologies, and more particularly, to a method for controlling a smart device by voice.

### BACKGROUND

The existing voice recognition technologies use a processing chip having the best performance and an omnidirectional microphone, and can reach a 3-meter recognition distance in an ideal situation. Generally a large conference room is equipped with multiple microphones at different locations of the conference room, and voice collected by the microphones is processed to achieve a better voice recognition effect.

In related art, for achieving the foregoing voice recognition effect in home environment, multiple microphones need to be arranged at different locations according to the arrangement of furniture and appliances, which therefore generates a high cost.

### SUMMARY

According to a first aspect of embodiments of the present disclosure, there is provided a method for controlling a smart device by voice. The method includes: receiving multiple voice data returned separately by multiple smart devices; processing the multiple voice data to obtain optimized voice data, the optimized voice data corresponding to a smart device to be controlled; and controlling the smart device corresponding to the optimized voice data based on the optimized voice data.

According to a second aspect of the embodiments of the present disclosure, there is provided a control device, including: a processor; and a memory configured to store instructions executable by a processor. The processor is configured to perform: receiving multiple voice data returned separately by multiple smart devices; processing the multiple voice data to obtain optimized voice data, the optimized voice data corresponding to a smart device to be controlled; and controlling the smart device corresponding to the optimized voice data based on the optimized voice data.

According to a third aspect of the embodiments of the present disclosure, there is provided a smart device, including: a processor; and a memory configured to store instructions executable by a processor. The processor is configured to perform: collecting voice data; and sending the voice data to a control device so that the control device controls the smart device based on optimized voice data, the optimized voice data being obtained in the control device based on the voice data collected by the smart device and other voice data collected by other smart devices.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart of a method for controlling a smart device by voice according to an exemplary embodiment of the present disclosure.

FIG. 2 is a flow chart of another method for controlling a smart device by voice according to an exemplary embodiment of the present disclosure.

FIG. 3 is a flow chart of another method for controlling a smart device by voice according to an exemplary embodiment of the present disclosure.

FIG. 4 shows a scenario of voice control on a smart device according to an exemplary embodiment of the present disclosure.

FIG. 5 is a block diagram of a device for controlling a smart device by voice according to an exemplary embodiment of the present disclosure.

FIG. 6 is a block diagram of another device for controlling a smart device by voice according to an exemplary embodiment of the present disclosure.

FIG. 7 is a block diagram of another device for controlling a smart device by voice according to an exemplary embodiment of the present disclosure.

FIG. 8 is a block diagram of another device for controlling a smart device by voice according to an exemplary embodiment of the present disclosure.

FIG. 9 is a block diagram of another device for controlling a smart device by voice according to an exemplary embodiment of the present disclosure.

FIG. 10 is a block diagram of another device for controlling a smart device by voice according to an exemplary embodiment of the present disclosure.

FIG. 11 is a block diagram of another device for controlling a smart device by voice according to an exemplary embodiment of the present disclosure.

FIG. 12 is a block diagram of another device for controlling a smart device by voice according to an exemplary embodiment of the present disclosure.

FIG. 13 is a block diagram of another device for controlling a smart device by voice according to an exemplary embodiment of the present disclosure.

FIG. 14 is a block diagram of another device for controlling a smart device by voice according to an exemplary embodiment of the present disclosure.

FIG. 15 is a block diagram of another device for controlling a smart device by voice according to an exemplary embodiment of the present disclosure.

FIG. 16 is a schematic structural diagram of a device for controlling a smart device by voice according to an exemplary embodiment of the present disclosure.

FIG. 17 is a schematic structural diagram of a device for controlling a smart device by voice according to an exemplary embodiment of the present disclosure.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

Terms used in the present disclosure are only for the purpose of description of specific embodiments, and are not intended to limit the present disclosure. As used in the present disclosure and appended claims, the singular forms “a/an”, “said” and “the” intend to also include the plural form, unless the content clearly dictates otherwise. It should also be understood that the term “and/or” used herein means to include arbitrary and all possible combinations of one or more items listed in association.

It should be understood that terms such as “first”, “second”, “third” and the like may be used herein for description of information. However, the information shall not be restricted to these terms. These terms are only intended to distinguish among information of the same type. For example, under the circumstance of not departing from the scope of the present disclosure, a first information can also be referred to as a second information, similarly, a second information can also be referred to as a first information. Depending on the context, term “if” used herein can be interpreted as “when”, “while” or “in response to determining”.

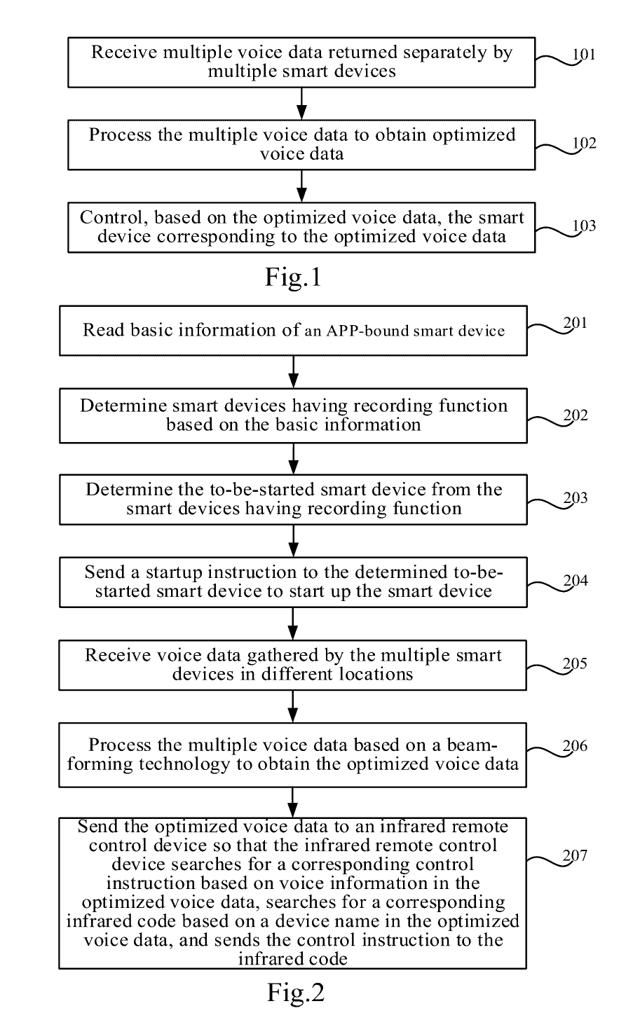

As shown in FIG. 1, which is a flow chart of a method for controlling a smart device by voice according to an exemplary embodiment of the present disclosure, and the method may be used in a control device such as a terminal, including the following steps.

In Step 101, multiple voice data returned separately by multiple smart devices is received.

The terminal of the present disclosure may be any smart terminal that can access Internet, for example, a mobile phone, a tablet, a PDA (Personal Digital Assistant) and so on. The terminal may be connected to a router via a WLAN and access a server in the public network via the router. The terminal of the present disclosure may receive the voice data by means of an APP (Application) such as Smarthome APP.

The smart device of the present disclosure includes a smart appliance, a wearable device and so on. The smart device has a communication module such as a WiFi (Wireless Fidelity) module for communicating with the terminal and a control center via a home router. The control center may be the infrared remote control center for controlling various smart devices.

In Step 102, the multiple voice data is processed to obtain optimized voice data. The optimized voice data corresponds to a smart device to be controlled.

In this step of the present disclosure, the multiple voice data is processed by using a beam-forming technology to obtain the optimized voice data.

In Step 103, the smart device corresponding to the optimized voice data is controlled based on the optimized voice data.

In the foregoing embodiment, the control device may process the voice data coming from different positions to obtain optimized voice data and control the smart device corresponding to the optimized voice data based on the optimized voice data, thereby achieving a voice control on the smart device. Furthermore, the optimized voice data is obtained by processing the voice data coming from different positions, which ensures the quality of the optimized voice data, the accuracy of voice recognition, and the voice control on the smart device.

As shown in FIG. 2, which is a flow chart of another method for controlling a smart device by voice shown according to an exemplary embodiment, the method may be used in the control device such as the terminal, including the following steps.

In Step 201, basic information of the APP-bound smart device is read.

In Step 202, smart devices having voice recording function are determined based on the basic information.

In this embodiment of the present disclosure, the terminal may receive the voice data and control the smart device using the Smarthome APP. The Smarthome APP is associated with multiple smart devices and used to store their basic information. The terminal may determine which smart devices have voice recording function by reading the basic information.

In Step 203, the to-be-started smart device is determined from the smart devices having voice recording function.

In this embodiment of the present disclosure, the terminal needs to determine the to-be-started smart device, namely, the smart device used to collect the voice data.

In one manner, the Smarthome APP of the terminal may display all the smart devices having voice recording function among the smart devices bound to it for the user to select. The user may select part or all of the smart devices as the to-be-started smart devices, and then the terminal determine, based on the user's selection, the smart device selected by the user as the to-be-started smart device having voice recording function.

In another manner, the terminal determines smart devices to be added into a start-up list. The terminal may determine the user's location based on positioning technology; search for locations of prestored smart devices having voice recording function; and then determine the smart devices having voice recording function located within a preset range with respect to the user's location as the to-be-started smart devices.

For example, if the terminal determines that the user is in a living room, then based on the preset range, such as a circle with the user's location as a center and 2 meters as its radius, and determines the smart devices having voice recording function located within the preset range are as the to-be-started smart devices.

Alternatively, the APP of the terminal stores locations of various smart devices, for example, devices 1-4 are placed in a living room, devices 5 and 6 are placed in a master bedroom, and devices 7 and 8 are placed in a second bedroom. When it is determined that the user is in the living room, the terminal determines that devices 1-4 are the to-be-started smart devices.

In the implementations of the embodiments of the present disclosure, if the number of the smart devices having voice recording function located within the preset range exceeds a given threshold value (for example, 6), historical usage data of the smart devices having voice recording function located within the preset range is then accessed, and the to-be-started smart device is determined based on the historical usage data. The historical usage data may include any one or multiple data of: the frequency of use, the time of the last use, and total duration of use. For example, the terminal may rank the smart devices based on the frequency of use, and determine the top four smart devices having high frequency of use as the to-be-started smart devices.

In Step 204, a starting instruction is sent to the determined to-be-started smart device to start the smart device.

In this step of the present disclosure, to start the smart device means starting the voice recording function of the smart device. The terminal may start the to-be-started smart device using the Smarthome APP.

In Step 205, the voice data collected by the multiple smart devices at different locations is received.

In Step 206, the multiple voice data is processed based on beam-forming technology to obtain the optimized voice data.

In this step of the present disclosure, the specific processing procedure may include: echo cancellation, signal processing and intensified processing, etc.

In Step 207, the optimized voice data is sent to an infrared remote control device so that the infrared remote control device searches for a corresponding control instruction based on the voice information contained in the optimized voice data, searches for a corresponding infrared code based on a device name contained in the optimized voice data, and sends the control instruction to the infrared code.

In this embodiment of the present disclosure, the infrared remote control device may extract voice information from the optimized voice data, for example, “turn on a television”, and searches for a corresponding control instruction from the prestored data. In addition, the optimized voice data also carries a device name such as “television”, and the infrared remote control device may search for a corresponding infrared code and send the control instruction to the infrared code, thereby achieving a voice control on the smart device.

In another manner, the terminal may also send the optimized voice data to a server so that the server searches for a corresponding control instruction based on voice information contained in the optimized voice data, and sends the control instruction and a device name contained in the optimized voice data to an infrared remote control device, which then sends the control instruction to an infrared code corresponding to the device name.

In the foregoing embodiments, the terminal may determine the to-be-started smart device in a variety of ways. For example, the terminal determines a smart device selected by the user as the to-be-started smart device, which may improve user's satisfaction regarding voice recording and optimize the user experience.

The terminal may also determine the to-be-started smart device by means of locating the user's position, which may determine a smart device that is closest to the user, thereby improving the effect of voice recording and ensuring the quality and recognition degree of the optimized voice data.

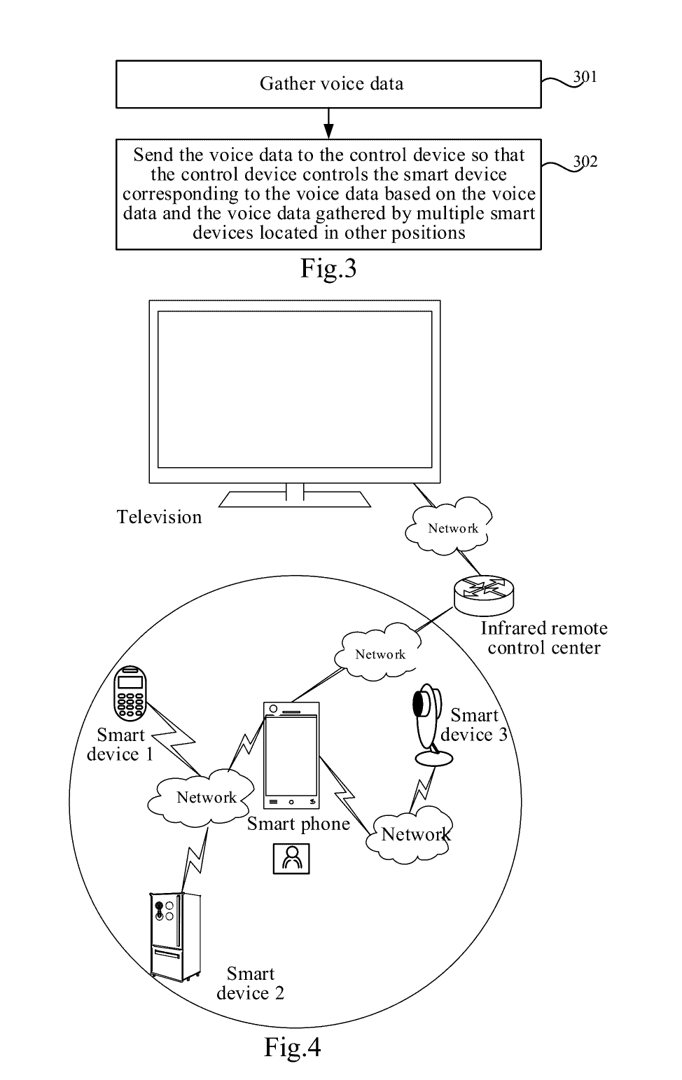

As shown in FIG. 3, which is a flow chart of another method for controlling a smart device by voice according to an exemplary embodiment, the method may be used in the smart device such as a smart appliance, a wearable device including the following steps.

In Step 301, voice data is collected.

In this embodiment of the present disclosure, the voice data from different locations is collected separately by multiple smart devices having voice recording function at different locations. The smart device may be started based on a starting instruction sent by the control device.

In Step 302, the voice data is sent to the control device so that the control device controls the smart device corresponding to the optimized voice data based on that voice data and the voice data collected by multiple smart devices located at other positions.

With reference to the embodiments as shown in FIG. 1 and FIG. 2, in a manner, the smart device may send the voice data to the control device such as the terminal. The terminal then processes the voice data by means of the beam-forming to obtain the optimized voice data and sends the optimized voice data to the infrared remote control center in which an infrared code library is stored. The infrared code library stores names of various smart devices and corresponding infrared codes as well as voice information and corresponding control instructions. The infrared remote control center extracts the voice information from the optimized voice data to obtain a device name, searches the infrared code library to obtain the infrared code corresponding to the device name, searches for a corresponding control instruction based on the voice information, and then sends the control instruction to the infrared code of the smart device to achieve a voice control on the smart device.

In another manner, after the smart device sends the optimized voice data to the terminal, the terminal may also send the optimized voice data to a server in which voice information and a corresponding control instruction are stored. The server extracts the voice information based on the optimized voice data, searches for the corresponding control instruction, and sends the control instruction along with the device name to an infrared remote controller. The infrared remote controller searches for corresponding infrared code based on the device name and sends the control instruction to the corresponding infrared code to achieve a voice control on the smart device.

In the foregoing embodiments, the smart device may send the collected voice data to the terminal so that the terminal processes the voice data to obtain the optimized voice data and controls the smart device based on the optimized voice data, thereby improving the quality and recognition degree of the optimized voice data and optimizing the user experience.

FIG. 4 shows a scenario of voice control on a smart device according to an exemplary embodiment of the present disclosure. The scenario as shown in FIG. 4 includes: a smart phone serving as the control device, a smart device 1, a smart device 2 and a smart device 3 for recording, and a television serving as a controlled object. The smart phone is installed with the Smarthome APP to control various bound smart devices.

The smart phone determines the user's location based on the positioning technology, searches for the locations of various prestored smart devices having voice recording function, determines the smart device 1, the smart device 2 and the smart device 3 having voice recording function located within the preset range with respect to the user's location (the circular region as shown in FIG. 4) as the to-be-started smart devices, starts them to perform recording, receives their voice data recorded at different locations, then processes the received voice data by means of beam-forming to obtain the optimized voice data “turn on the television”. The smart phone sends the optimized voice data to the infrared remote control center so that the infrared remote control center searches for a corresponding infrared code based on the device name “television” in the optimized voice data, searches for a control instruction based on the optimized voice data, an sends the control instruction to the infrared code to achieve a control on the television.

In the application scenario as shown in FIG. 4, the specific process for achieving the voice control on the smart device may refer to the foregoing descriptions of FIGS. 1-3, which is not elaborated herein.

Corresponding to the embodiments of the foregoing method for controlling a smart device by voice, the present disclosure further provides embodiments of the device for controlling a smart device by voice as well as the control device and the smart device thereof.

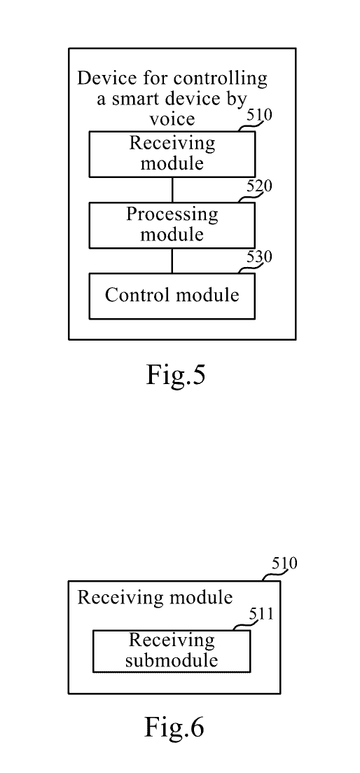

As shown in FIG. 5, which is a block diagram of a device for controlling a smart device by voice according to an exemplary embodiment of the present disclosure, the device may include: a receiving module 510, a processing module 520 and a control module 530.

The receiving module 510 is configured to receive voice data returned separately by multiple smart devices.

The processing module 520 is configured to process the multiple voice data received by the receiving module 510 to obtain optimized voice data.

The control module 530 is configured to control the smart device corresponding to the optimized voice data, based on the optimized voice data obtained by the processing module 520.

In the foregoing embodiment, the control device may process voice data collected from different locations to obtain optimized voice data, and control the smart device corresponding to the optimized voice data based on the optimized voice data, thereby achieving a voice control on the smart device, providing convenience for the user to control the smart device, and optimizing the user experience.

As shown in FIG. 6, a block diagram of another device for controlling a smart device by voice according to an exemplary embodiment of the present disclosure, in this embodiment, on the basis of the embodiment as shown in FIG. 5, the receiving module 510 may include a receiving submodule 511.

The receiving submodule 511 is configured to receive voice data returned separately by multiple smart devices located at different positions.

In the foregoing embodiment, the control device may receive voice data collected by smart devices located at multiple positions, and process the voice data from different positions to obtain optimized voice data, thereby ensuring the quality of the optimized voice data, improving the accuracy of voice recognition, and achieving the voice control on the smart devices.

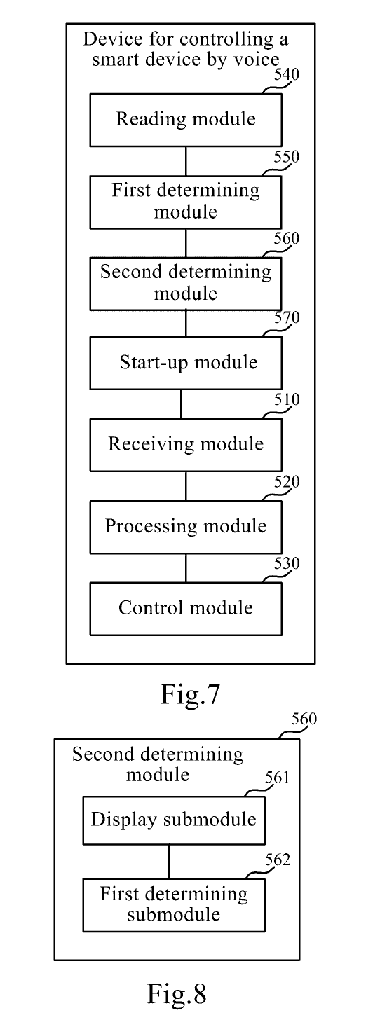

As shown in FIG. 7, a block diagram of another device for controlling a smart device by voice according to an exemplary embodiment of the present disclosure, in this embodiment, on the basis of the embodiment shown in FIG. 5, the device may further include: a reading module 540, a first determining module 550, a second determining module 560 and a start-up module 570.

The reading module 540 is configured to read basic information of an APP-bound smart device.

The first determining module 550 is configured to determine smart devices having voice recording function, based on the basic information read by the reading module 540.

The second determining module 560 is configured to determine a to-be-started smart device from the smart devices having voice recording function determined by the first determining module 550.

The start-up module 570 is configured to send a starting instruction to the to-be-started smart device determined by the second determining module 560 to start the smart device.

In the foregoing embodiment, the control device may first determine the smart devices having voice recording function, and then determine the to-be-started smart device from the smart devices having voice recording function, thereby ensuring that the started smart device can perform recording.

As shown in FIG. 8, which is a block diagram of another device for controlling a smart device by voice according to an exemplary embodiment of the present disclosure, in this embodiment, on the basis of the embodiment shown in FIG. 7, the second determining module 560 may include a display submodule 561 and a first determining submodule 562.

The display submodule 561 is configured to display a list of the smart devices having voice recording function.

The first determining submodule 562 is configured to determine a smart device selected by the user as the to-be-started smart device having voice recording function, based on user's selection from the list displayed by the display submodule 561.

In the foregoing embodiment, the control device may determine the to-be-started smart device based on user's selection, which may better meet the user's demands and improve the user experience.

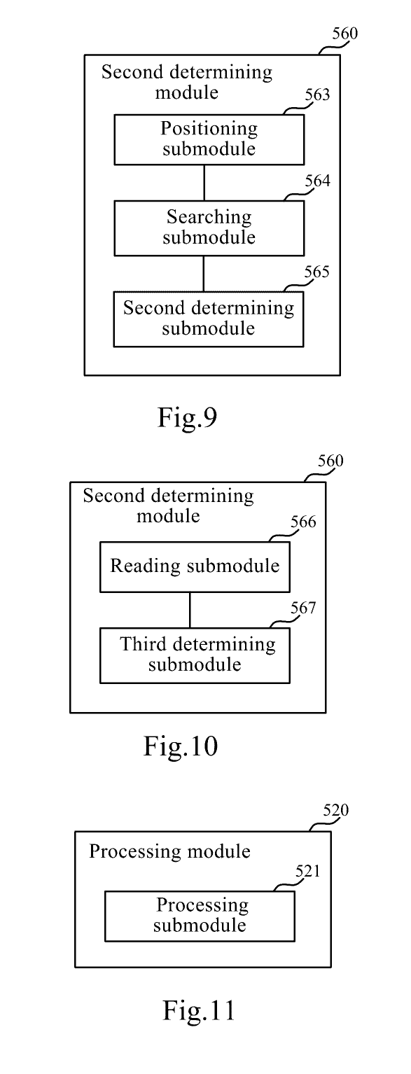

As shown in FIG. 9, a block diagram of another device for controlling a smart device by voice according to an exemplary embodiment of the present disclosure, in this embodiment, on the basis of the embodiment shown in FIG. 7, the second determining module 560 may include a positioning submodule 563, a searching submodule 564 and a second determining submodule 565.

The positioning submodule 563 is configured to locate a user's position based on positioning technology.

The searching submodule 564 is configured to locate the prestored smart devices having voice recording function.

The second determining submodule 565 is configured to determine the smart device having voice recording function, which is located within a preset range with respect to the user's location and is positioned by the positioning submodule 563, as the to-be-started smart device.

In the foregoing embodiment, the control device may locate a user, and then determine the to-be-started smart device based on the user's location. This manner can ensure that the to-be-started smart device is near the user's location, thereby ensuring that clear voice data can be collected, the subsequent optimized voice data can be recognized easily, and the accurate control of the smart device can be achieved.

As shown in FIG. 10, a block diagram of another device for controlling a smart device by voice according to an exemplary embodiment of the present disclosure, in this embodiment, on the basis of the embodiment shown in FIG. 9, the second determining module 560 may further include a reading submodule 566 and a third determining submodule 567.

The reading submodule 566 is configured to read historical usage data of the smart devices having voice recording function located within the preset range, if the number of smart devices determined by the second determining submodule 565 exceeds a given threshold value.

The third determining submodule 567 is configured to determine the to-be-started smart device, based on the historical usage data read by the reading submodule 566.

The historical use data read by the reading submodule 566 includes any one or multiple items of: the frequency of use, the time of last use, and the total duration of use.

In the foregoing embodiment, the control device may also determine the to-be-started smart device with reference to the historical usage data of the smart device. The quality of the recorded voice data can be ensured because the historical usage data can reflect, to a certain extent, the performance of the smart device.

As shown in FIG. 11, a block diagram of another device for controlling a smart device by voice according to an exemplary embodiment of the present disclosure, in this embodiment, on the basis of the embodiment shown in FIG. 5, the processing module 520 may include a processing submodule 521.

The processing submodule 521 is configured to process the multiple voice data received by the receiving module 510 to obtain optimized voice data, based on beam-forming technology.

In the foregoing embodiment, the control device may process multiple voice data based on beam-forming technology, thereby further improving the success rate of voice recognition.

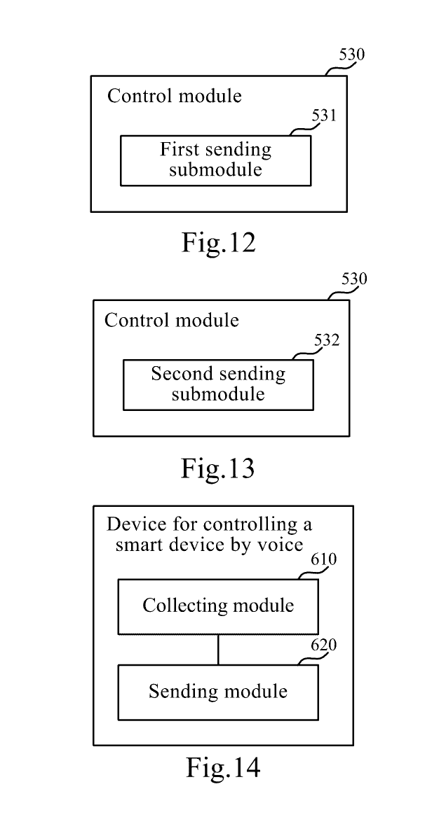

As shown in FIG. 12, a block diagram of another device for controlling a smart device by voice according to an exemplary embodiment of the present disclosure, in this embodiment, on the basis of the embodiment shown in FIG. 5, the control module 530 may include a first sending submodule 531.

The first sending submodule 531 is configured to send the optimized voice data obtained by the processing module 520 to an infrared remote control device, so that the infrared remote control device searches for a corresponding control instruction based on the voice information contained in the optimized voice data, searches for a corresponding infrared code based on a device name contained in the optimized voice data, and sends the control instruction to the infrared code.

In the foregoing embodiment, the control device may send the optimized voice data to an infrared remote control center so that the infrared remote control center implements an accurate voice control on the smart device.

As shown in FIG. 13, a block diagram of another device for controlling a smart device by voice according to an exemplary embodiment of the present disclosure, in this embodiment, on the basis of the embodiment shown in FIG. 5, the control module 530 may include a second sending submodule 532.

The second sending submodule 532 is configured to send the optimized voice data obtained by the processing module to a server, so that the server searches for a corresponding control instruction based on the voice information contained in the optimized voice data, and sends the control instruction along with a device name contained in the optimized voice data to an infrared remote control device. The infrared remote control device then sends the control instruction to an infrared code corresponding to the device name.

In the foregoing embodiment, the control device may send the optimized voice data to the server, so that the server and the infrared remote control center implements an accurate voice control on the smart device.

The embodiments of the device for controlling a smart device by voice as shown in FIG. 5-FIG. 13 may be used in the control device.

As shown in FIG. 14, a block diagram of another device for controlling a smart device by voice according to an exemplary embodiment of the present disclosure, the device may be used in the smart device and may include a collecting module 610 and a sending module 620.

The collecting module 610 is configured to collect voice data.

The sending module 620 is configured to send the voice data collected by the collecting module 610 to a control device, so that the control device controls a smart device corresponding to the voice data, based on the voice data.

In the foregoing embodiment, the smart device may send collected voice data to the control device, so that the control device can control the smart device corresponding to the voice data based on that voice data and voice data collected by multiple smart devices located at other positions, thereby implementing an accurate voice control on the smart device and optimizing the user experience.

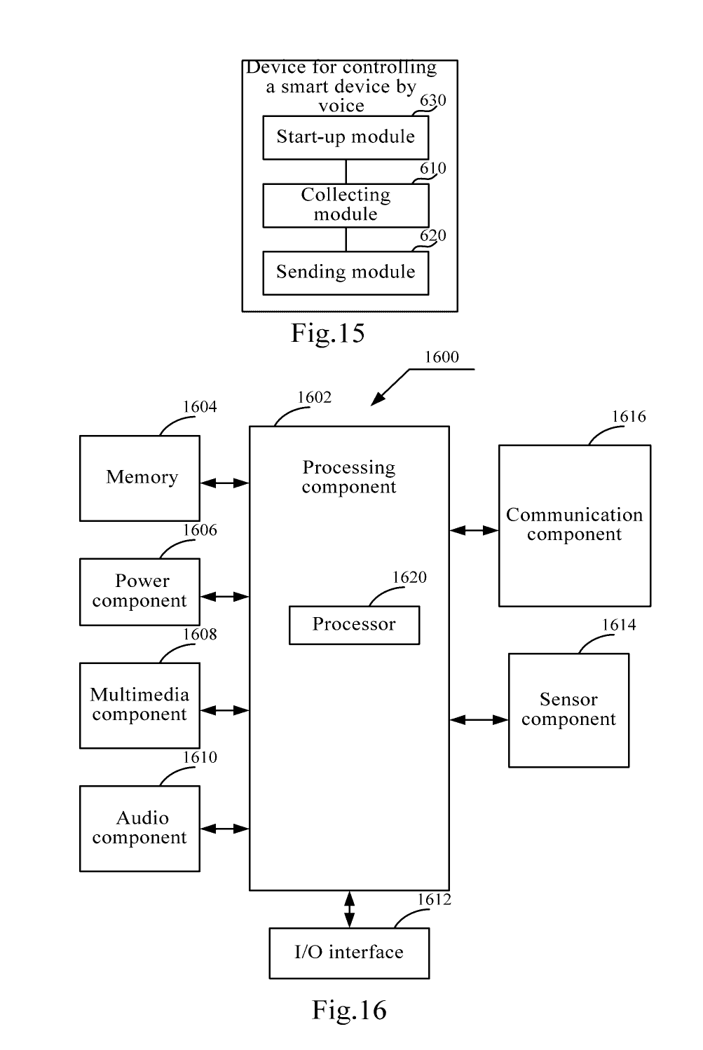

As shown in FIG. 15, a block diagram of another device for controlling a smart device by voice according to an exemplary embodiment of the present disclosure, in this embodiment, on the basis of the embodiment as shown in the foregoing FIG. 14, the device may further include a start-up module 630.

The start-up module 630 is configured to start up based on a starting instruction sent by the control device.

The embodiments of the device for controlling a smart device by voice as shown in FIG. 14-FIG. 15 may be used in the smart device for collecting voice data.

Specific implementations of functions and roles of units in the above device can be referred to the implementations of corresponding steps in above methods in detail, and thus are not elaborated herein.

Device embodiments are substantially related to the method embodiments, thus method embodiments can serve as reference. Device embodiments set forth above are only exemplary. The modules described as detached parts may be or may not be separated physically, and the parts displayed as modules may be or may not be physical modules, i.e., either located at the one place, or distributed on a plurality of network elements. Parts of the modules or the entire modules can be selected according to the actual needs for realizing the solutions of the present disclosure. It is conceivable and executable for those having ordinary skill in the art without making creative effort.

FIG. 16 is a schematic structural diagram of a device for controlling a smart device by voice (such as the control device) 1600 according to an exemplary embodiment of the present disclosure. For example, the device 1600 may be a mobile phone, a computer, a digital broadcasting terminal, a message sending and receiving device, a games console, a tablet device, a medical device, a fitness device, a personal digital assistant, or the like which has an Internet accessing function.

Referring to FIG. 16, the device 1600 may include one or more of the following components: a processor component 1602, a memory 1604, a power component 1606, a multimedia component 1608, an audio component 1610, an input/output (I/O) interface 1612, a sensor component 1614 and a communications component 1616.

The processing component 1602 typically controls overall operations of the device 1600, such as the operations associated with display, telephone calls, data communications, camera operations, and recording operations. The processing component 1602 may include one or more processors 1620 to execute instructions to perform all or part of the steps in the above described methods. Moreover, the processing component 1602 may include one or more modules which facilitate the interaction between the processing component 1602 and other components. For instance, the processing component 1602 may include a multimedia module to facilitate the interaction between the multimedia component 1608 and the processing component 1602.

The memory 1604 is configured to store various types of data to support the operation of the device 1600. Examples of such data include instructions for any applications or methods operated on the device 1600, contact data, phonebook data, messages, pictures, video, etc. The memory 1604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1606 provides power to various components of the device 1600. The power component 1606 may include a power management system, one or more power sources, and any other components associated with the generation, management, and distribution of power in the device 1600.

The multimedia component 1608 includes a screen providing an output interface between the device 1600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1608 includes a front camera and/or a rear camera. The front camera and the rear camera may receive an external multimedia datum while the device 1600 is in an operation mode, such as a photographing mode or a video mode. Each of the front camera and the rear camera may be a fixed optical lens system or have focus and optical zoom capability.

The audio component 1610 is configured to output and/or input audio signals. For example, the audio component 1610 includes a microphone (“MIC”) configured to receive an external audio signal when the device 1600 is in an operation mode, such as a call mode, a recording mode, and a voice recognition mode. The received audio signal may be further stored in the memory 1604 or transmitted via the communication component 1616. In some embodiments, the audio component 1610 further includes a speaker to output audio signals.

The I/O interface 1612 provides an interface between the processing component 1602 and peripheral interface modules, such as a keyboard, a click wheel, buttons, and the like. The buttons may include, but are not limited to, a home button, a volume button, a starting button, and a locking button.

The sensor component 1614 includes one or more sensors to provide status assessments of various aspects of the device 1600. For instance, the sensor component 1614 may detect an open/closed status of the device 1600, relative positioning of components, e.g., the display and the keypad, of the device 1600, a change in position of the device 1600 or a component of the device 1600, a presence or absence of user contact with the device 1600, an orientation or an acceleration/deceleration of the device 1600, and a change in temperature of the device 1600. The sensor component 1614 may include a proximity sensor configured to detect the presence of nearby objects without any physical contact. The sensor component 1614 may also include a light sensor, such as a CMOS or CCD image sensor, for use in imaging applications. In some embodiments, the sensor component 1614 may also include an accelerometer sensor, a gyroscope sensor, a magnetic sensor, a pressure sensor, or a temperature sensor.

The communication component 1616 is configured to facilitate communication, wired or wirelessly, between the device 1600 and other devices. The device 1600 can access a wireless network based on a communication standard, such as WiFi, 2G, or 3G, or a combination thereof. In one exemplary embodiment, the communication component 1616 receives a broadcast signal or broadcast associated information from an external broadcast management system via a broadcast channel. In one exemplary embodiment, the communication component 1616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1604, executable by the processor 1620 in the device 1600, for performing the above-described methods performed by a control device. For example, the non-transitory computer-readable storage medium may be a ROM, a RAM, a CD-ROM, a magnetic tape, a floppy disc, an optical data storage device, and the like.

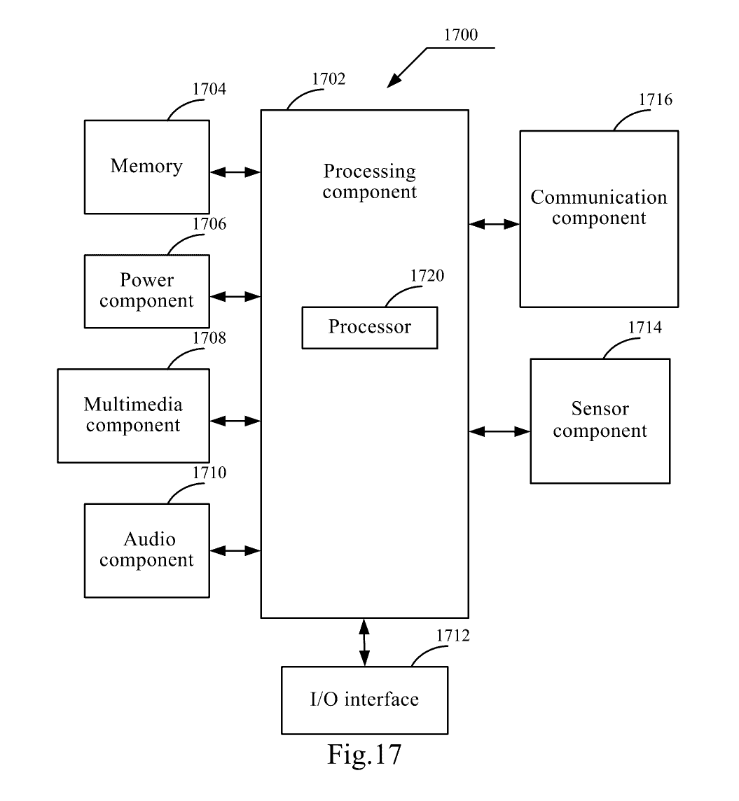

As shown in FIG. 17, FIG. 17 is a schematic structural diagram of a device for controlling a smart device by voice (such as the smart device) 1700 according to an exemplary embodiment of the present disclosure. For example, the device 1700 may be a mobile phone, a computer, a digital broadcasting terminal, a message sending and receiving device, a games console, a tablet device, a medical device, a fitness device, a personal digital assistant, or the like which has a communication module

Referring to FIG. 17, the device 1700 may include one or more of the following components: a processor component 1702, a memory 1704, a power component 1706, a multimedia component 1708, an audio component 1710, an input/output (I/O) interface 1712, a sensor component 1714 and a communications component 1717.

The processing component 1702 typically controls overall operations of the device 1700, such as the operations associated with display, telephone calls, data communications, camera operations, and recording operations. The processing component 1702 may include one or more processors 1720 to execute instructions to perform all or part of the steps in the above described methods. Moreover, the processing component 1702 may include one or more modules which facilitate the interaction between the processing component 1702 and other components. For instance, the processing component 1702 may include a multimedia module to facilitate the interaction between the multimedia component 1708 and the processing component 1702.

The memory 1704 is configured to store various types of data to support the operation of the device 1700. Examples of such data include instructions for any applications or methods operated on the device 1700, contact data, phonebook data, messages, pictures, video, etc. The memory 1704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1706 provides power to various components of the device 1700. The power component 1706 may include a power management system, one or more power sources, and any other components associated with the generation, management, and distribution of power in the device 1700.

The multimedia component 1708 includes a screen providing an output interface between the device 1700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1708 includes a front camera and/or a rear camera. The front camera and the rear camera may receive an external multimedia datum while the device 1700 is in an operation mode, such as a photographing mode or a video mode. Each of the front camera and the rear camera may be a fixed optical lens system or have focus and optical zoom capability.

The audio component 1710 is configured to output and/or input audio signals. For example, the audio component 1710 includes a microphone (“MIC”) configured to receive an external audio signal when the device 1700 is in an operation mode, such as a call mode, a recording mode, and a voice recognition mode. The received audio signal may be further stored in the memory 1704 or transmitted via the communication component 1717. In some embodiments, the audio component 1710 further includes a speaker to output audio signals.

The I/O interface 1712 provides an interface between the processing component 1702 and peripheral interface modules, such as a keyboard, a click wheel, buttons, and the like. The buttons may include, but are not limited to, a home button, a volume button, a starting button, and a locking button.

The sensor component 1714 includes one or more sensors to provide status assessments of various aspects of the device 1700. For instance, the sensor component 1714 may detect an open/closed status of the device 1700, relative positioning of components, e.g., the display and the keypad, of the device 1700, a change in position of the device 1700 or a component of the device 1700, a presence or absence of user contact with the device 1700, an orientation or an acceleration/deceleration of the device 1700, and a change in temperature of the device 1700. The sensor component 1714 may include a proximity sensor configured to detect the presence of nearby objects without any physical contact. The sensor component 1714 may also include a light sensor, such as a CMOS or CCD image sensor, for use in imaging applications. In some embodiments, the sensor component 1714 may also include an accelerometer sensor, a gyroscope sensor, a magnetic sensor, a pressure sensor, or a temperature sensor.

The communication component 1717 is configured to facilitate communication, wired or wirelessly, between the device 1700 and other devices. The device 1700 can access a wireless network based on a communication standard, such as WiFi, 2G, or 3G, or a combination thereof. In one exemplary embodiment, the communication component 1717 receives a broadcast signal or broadcast associated information from an external broadcast management system via a broadcast channel. In one exemplary embodiment, the communication component 1717 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1704, executable by the processor 1720 in the device 1700, for performing the above-described methods performed by a smart device. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. The present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

The embodiments set forth above are only illustrated as preferred embodiments of the present disclosure, and are not intended to limit the present disclosure. All modifications, equivalent substitutions and improvements made within the spirit and principles of the present disclosure shall fall within the protection scope of the present disclosure.

What is claimed is:

1. A method for controlling a smart device by voice, comprising:
receiving multiple voice data returned separately by multiple smart devices;
processing the multiple voice data to obtain optimized voice data, the optimized voice data corresponding to a smart device to be controlled; and
controlling the smart device corresponding to the optimized voice data based on the optimized voice data.

2. The method of claim 1, wherein the multiple smart devices are located in different positions.

3. The method of claim 1, wherein before receiving the multiple voice data, the method further comprises:
reading basic information of an APP-bound smart device;
determining, based on the basic information, smart devices having voice recording function;
determining a to-be-started smart device from the smart devices having voice recording function; and
sending a startup instruction to the determined to-be-started smart device to start up the smart device.

4. The method of claim 3, wherein determining the to-be-started smart device comprises:
displaying a list of the smart devices having voice recording function; and
based on a user's selecting operation on the list, determining a smart device selected by the user as the to-be-started smart device having voice recording function.

5. The method of claim 3, wherein determining the to-be-started smart device comprises:
positioning a user's location based on positioning technology;
locating the smart devices having voice recording function which are prestored; and
determining a smart device having voice recording function located within a setting range including the user's location as the to-be-started smart device.

6. The method of claim 5, further comprising:
if the number of the smart devices having voice recording function located within the setting range exceeds a given threshold value, reading historical use data of the smart devices having voice recording function located within the setting range; and
determining, based on the historical use data, the to-be-started smart device.

7. The method of claim 6, wherein the historical use data comprises any one or more items selected from a group of frequency of use, time of last use, and total duration of use.

8. The method of claim 1, wherein controlling the smart device corresponding to the optimized voice data comprises:
sending the optimized voice data to an infrared remote control device so that the infrared remote control device searches for a corresponding control instruction based on voice information in the optimized voice data, searches for a corresponding infrared code based on a device name in the optimized voice data, and sends the control instruction to the infrared code.

9. The method of claim 1, wherein controlling the smart device corresponding to the optimized voice data comprises:
sending the optimized voice data to a server so that the server searches for a corresponding control instruction based on voice information in the optimized voice data, and sends the searched control instruction and a device name in the optimized voice data to an infrared remote control device, which enable the infrared remote control device to send the control instruction to an infrared code corresponding to the device name.

10. A control device, comprising:
a processor; and
a memory configured to store instructions executable by a processor,
wherein the processor is configured to perform:
receiving multiple voice data returned separately by multiple smart devices;
processing the multiple voice data to obtain optimized voice data, the optimized voice data corresponding to a smart device to be controlled; and
controlling the smart device corresponding to the voice data based on the optimized voice data.

11. The device of claim 10, wherein the multiple smart devices are located in different positions.

12. The device of claim 10, wherein before receiving the multiple voice data, the processor is further configured to perform:
reading basic information of an APP-bound smart device;
determining, based on the basic information, smart devices having voice recording function;
determining a to-be-started smart device from the smart devices having voice recording function; and
sending a startup instruction to the determined to-be-started smart device to start up the smart device.

13. The device of claim 12, wherein determining the to-be-started smart device comprises:
displaying a list of the smart devices having voice recording function; and
based on a user's selecting operation on the list, determining a smart device selected by the user as the to-be-started smart device having voice recording function.

14. The device of claim 12, wherein determining the to-be-started smart device comprises:
positioning a user's location based on positioning technology;
locating the smart devices having voice recording function which are prestored; and
determining a smart device having voice recording function located within a setting range including the user's location as the to-be-started smart device.

15. The device of claim 14, wherein the processor is further configured to perform:
if the number of the smart devices having voice recording function located within the setting range exceeds a given threshold value, reading historical use data of the smart devices having voice recording function located within the setting range; and
determining, based on the historical use data, the to-be-started smart device.

16. The device of claim 15, wherein the historical use data comprises any one or more items selected from a group of frequency of use, the time of last use, and total duration of use.

17. The device of claim 10, wherein controlling the smart device corresponding to the voice data comprises:
sending the optimized voice data to an infrared remote control device so that the infrared remote control device searches for a corresponding control instruction based on voice information in the optimized voice data, searches for a corresponding infrared code based on a device name in the optimized voice data, and sends the control instruction to the infrared code.

18. The device of claim 10, wherein controlling the smart device corresponding to the voice data comprises:
sending the optimized voice data to a server so that the server searches for a corresponding control instruction based on voice information in the optimized voice data, and sends the searched control instruction and a device name in the optimized voice data to an infrared remote control device, which enable the infrared remote control device to send the control instruction to an infrared code corresponding to the device name.

19. A smart device, comprising:
a processor; and
a memory configured to store instructions executable by a processor,
wherein the processor is configured to perform:
collecting voice data; and
sending the voice data to a control device so that the control device controls the smart device based on optimized voice data, the optimized voice data being obtained in the control device based on the voice data collected by the smart device and other voice data collected by other smart devices.

20. The device of claim 19, wherein before collecting the voice data, the processor is further configured to perform:
starting the smart device based on a startup instruction sent by the control device.
